(19) United States
(12) Patent Application Publication
(10) Pub. No.: US 2007/0230567 A1
(43) Pub. Date: Oct. 4, 2007

(54) SLICE GROUPS AND DATA PARTITIONING IN SCALABLE VIDEO CODING

(75) Inventors: Ye-Kui Wang, Tampere (FI); Miska Hannuksela, Ruutana (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/690,015

(22) Filed: Mar. 22, 2007

Related U.S. Application Data
(60) Provisional application No. 60/786,496, filed on Mar. 28, 2006.

(51) Int. Cl. H04B 1/66; H04N 7/12

(52) U.S. Cl. 375/240.1; 375/240.26

(57) ABSTRACT

A system and method for separating the data needed for inter-layer prediction and data unneeded for inter-layer prediction in the bitstream. For the coded data of a picture, the decoding of the data needed for inter-layer prediction is performed independent of the data not needed for inter-layer prediction, and it is identified whether the data is needed for inter-layer prediction.

### FIELD OF THE INVENTION

The present invention relates generally to video encoding and decoding. More particularly, the present invention relates to scalable video encoding and decoding.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also know as ISO/IEC MPEG-4 AVC). In addition, there are currently efforts underway with regards to the development of new video coding standards. One such standard under development is the scalable video coding (SVC) standard, which will become the scalable extension to the H.264/AVC standard. Another such effort involves the development of China video coding standards.

SVC can provide scalable video bitstreams. A portion of a scalable video bitstream can be extracted and decoded with a degraded playback visual quality. A scalable video bitstream contains a non-scalable base layer and one or more enhancement layers. An enhancement layer may enhance the temporal resolution (i.e. the frame rate), the spatial resolution, or simply the quality of the video content represented by the lower layer or part thereof. In some cases, data of an enhancement layer can be truncated after a certain location, even at arbitrary positions, and each truncation position can include some additional data representing increasingly enhanced visual quality. Such scalability is referred to as fine-grained (granularity) scalability (FGS). In contrast to FGS, the scalability provided by a quality enhancement layer that does not provide fined-grained scalability is referred as coarse-grained scalability (CGS). Base layers can be designed to be FGS scalable as well.

The mechanism for providing temporal scalability in the latest SVC specification is referred to as the “hierarchical B pictures” coding structure. This feature is fully supported by AVC, and the signaling portion can be performed by using sub-sequence-related supplemental enhancement information (SEI) messages.

For mechanisms to provide spatial and CGS scalabilities, a conventional layered coding technique similar to that used in earlier standards is used with some new inter-layer prediction methods. Data that could be inter-layer predicted includes intra texture, motion and residual data. Single-loop decoding is enabled by a constrained intra texture prediction mode, whereby the inter-layer intra texture prediction can be applied to macroblocks (MBs) for which the corresponding block of the base layer is located inside intra MBs. At the same time, those intra MBs in the base layer use constrained intra prediction. In single-loop decoding, the decoder needs to perform motion compensation and full picture reconstruction only for the scalable layer desired for playback (called the desired layer). For this reason, the decoding complexity is greatly reduced. All of the layers other than the desired layer do not need to be fully decoded because all or part of the data of the MBs not used for inter-layer prediction (be it inter-layer intra texture prediction, inter-layer motion prediction or inter-layer residual prediction) are not needed for reconstruction of the desired layer.

The spatial scalability has been generalized to enable the base layer to be a cropped and zoomed version of the enhancement layer. The quantization and entropy coding modules were adjusted to provide FGS capability. The coding mode is referred to as progressive refinement, wherein successive refinements of the transform coefficients are encoded by repeatedly decreasing the quantization step size and applying a “cyclical” entropy coding akin to sub-bitplane coding.

The scalable layer structure in the current draft SVC standard is characterized by three variables, referred to as temporal_level, dependency_id and quality_level, that are signaled in the bit stream or can be derived according to the specification. temporal_level is used to indicate the temporal layer hierarchy or frame rate. A layer comprising pictures of a smaller temporal_level value has a smaller frame rate than a layer comprising pictures of a larger temporal_level. dependency_id is used to indicate the inter-layer coding dependency hierarchy. At any temporal location, a picture of a smaller dependency_id value may be used for inter-layer prediction for coding of a picture with a larger dependency_id value. quality_level is used to indicate FGS layer hierarchy. At any temporal location and with identical dependency_id value, an FGS picture with quality_level value equal to QL uses the FGS picture or base quality picture (i.e., the non-FGS picture when QL-1=0) with quality_level value equal to QL-1 for inter-layer prediction.

In single-loop decoding of scalable video including at least two quality or spatial scalable layers, only a portion of a coded picture in a lower layer is used for prediction of the corresponding coded picture in a higher layer (i.e. for inter-layer prediction). Therefore, if a sender knows the scalable layer desired for playback in the receivers, the bitrate used for transmission could be reduced by omitting those portions that are not used for inter-layer prediction and not in any of the scalable layers desired for playback. It should be noted that, in the case of a multicast or broadcast, where different clients may desire different layers for playback, these layers are called desired layers. Currently in the SVC standard, coded data not required for inter-layer prediction is interleaved in the same slices with the data required for inter-layer prediction. It is therefore impossible to discard the data not required for inter-layer prediction, because removal of syntax elements not-required inter-layer prediction would result in a bitstream that is invalid (i.e. a bitstream that is not compliant with the bitstream syntax specified in the current SVC standard).

The Joint Video Team (JVT) is currently working on the development of the SVC standard. The JVT-R050r1 and JVT-R064 contributions previously attempted to utilize “unneeded data” to improve the performance of SVC in certain application scenarios. JVT-R050r1 briefly proposed that discardable residuals be coded in a separate Network Abstraction Layer (NAL) unit or slice with the NAL discardable_flag set, where the discardable_flag indicated that a NAL unit is not required for decoding upper layers. However, only residual data is mentioned and it was not specified how to encode those “discardable” residuals to a separate NAL unit or slice. According to the current SVC design, this is impossible unless those MBs having residual data not required for inter-layer prediction are consecutive in raster scan order, which is not likely. JVT-R064 proposed to force all of the MBs to not be used for inter-layer prediction for a set of pictures.

PCT patent application WO 02/17644 proposed the derivation of virtual frames on the basis of a subset of coded pictures. Virtual frames could then be used as prediction references for other frames. This application is primarily directed to inter prediction from virtual frames and assumes multi-loop decoding (i.e., one loop for virtual frames and another one for “complete” frames). However the system described in this application is only general in nature. It should also be noted that coding standards prior to the SVC standard used multi-loop decoding, in which a decoded picture in a lower layer is used as a prediction reference for the corresponding picture in a higher layer. Thus, the problem identified herein was not present in earlier coding standards.

It would therefore be desirable to develop a system and method for addressing the issues outlined above.

### SUMMARY OF THE INVENTION

The present invention provides a system and method for separating the data needed for inter-layer prediction and data unneeded for inter-layer prediction in the bitstream. For the coded data of a picture, the decoding of the data needed for inter-layer prediction is performed independent of the data not needed for inter-layer prediction, and it is identified whether the data is needed for inter-layer prediction.

The present invention includes a video encoder (and encoding method) for separating data needed for inter-layer prediction and not needed for inter-layer prediction. In addition, the present invention also includes a video decoder (and decoding method) identifying data not needed for inter-layer prediction and not in the desired layer for playback, as well as omitting the decoding of such identified data.

As discussed herein, various embodiments of present invention provides for at least one important advantage over conventional systems. In particular, the present invention enables the easy discarding of unneeded data in single-loop decoding, such that the transmission bandwidth is saved. Unlike the JVT-R050r1 contribution, the present invention targets motion data in addition to needed and unneeded residual data. Additionally and unlike the JVT-R050r1 contribution, the present invention includes the use of slice groups and data partitioning to separate needed and unneeded data into different NAL units.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 shows a generic multimedia communications system for use with the present invention;

FIG. 2 is a perspective view of a mobile telephone that can be used in the implementation of the present invention; and

FIG. 3 is a schematic representation of the telephone circuitry of the mobile telephone of FIG. 2.

### DETAILED DESCRIPTION OF THE PREFERRED EMBODIMENTS

The present invention provides a system and method for separating the data needed for inter-layer prediction and data unneeded for inter-layer prediction in the bitstream. For the coded data of a picture, the decoding of the data needed for inter-layer prediction is performed independent of the data not needed for inter-layer prediction, and it is identified whether the data is needed for inter-layer prediction.

The present invention includes a video encoder (and encoding method) for separating data needed for inter-layer prediction and not needed for inter-layer prediction. In addition, the present invention also includes a video decoder (and decoding method) identifying data not needed for inter-layer prediction and not in the desired layer for playback, as well as omitting the decoding of such identified data.

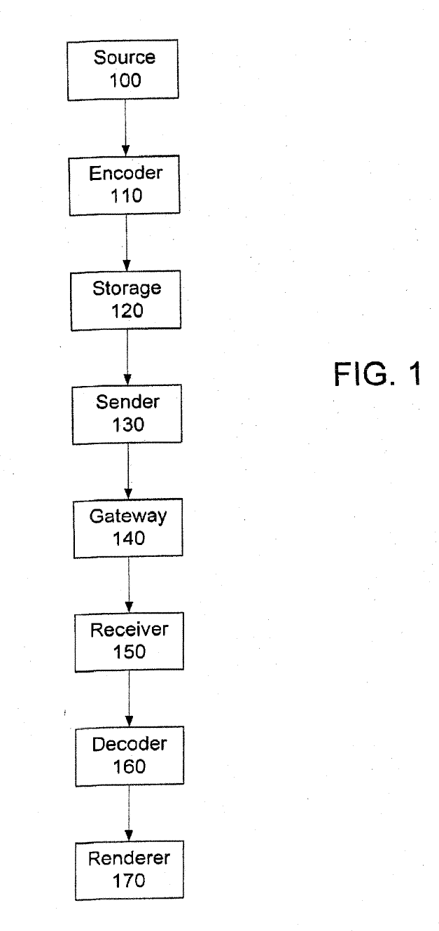

FIG. 1 shows a generic multimedia communications system for use with the present invention. As shown in FIG. 1, a data source 100 provides a source signal in an analog, uncompressed digital, or compressed digital format, or any combination of these formats. An encoder 110 encodes the source signal into a coded media bitstream. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the following only one encoder 110 is considered to simplify the description without a lack of generality.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. Some systems operate “live”, i.e. omit storage and transfer coded media bitstream from the encoder 110 directly to the sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the sender 130 may reside in the same physical device or they may be included in separate devices. The encoder 110 and sender 130 may operate with live real-time content, in which case the coded media bitstream is typically not stored permanently, but rather buffered for small periods of time in the content encoder 110 and/or in the sender 130 to smooth out variations in processing delay, transfer delay, and coded media bitrate.

The sender 130 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the sender 130 encapsulates the coded media bitstream into packets. For example, when RTP is used, the sender 130 encapsulates the coded media bitstream into RTP packets according to an RTP payload format. Typically, each media type has a dedicated RTP payload format. It should be again noted that a system may contain more than one sender 130, but for the sake of simplicity, the following description only considers one sender 130.

The sender 130 may or may not be connected to a gateway 140 through a communication network. The gateway 140 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 140 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is called an RTP mixer and acts as an endpoint of an RTP connection.

The system includes one or more receivers 150, typically capable of receiving, de-modulating, and de-capsulating the transmitted signal into a coded media bitstream. The codec media bitstream is typically processed further by a decoder 160, whose output is one or more uncompressed media streams. Finally, a renderer 170 may reproduce the uncompressed media streams with a loudspeaker or a display, for example. The receiver 150, decoder 160, and renderer 170 may reside in the same physical device or they may be included in separate devices.

Scalability in terms of bitrate, decoding complexity, and picture size is a desirable property for heterogeneous and error prone environments. This property is desirable in order to counter limitations such as constraints on bit rate, display resolution, network throughput, and computational power in a receiving device.

Communication devices of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

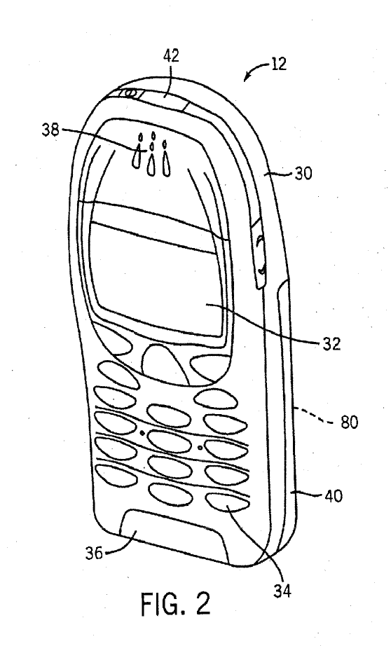

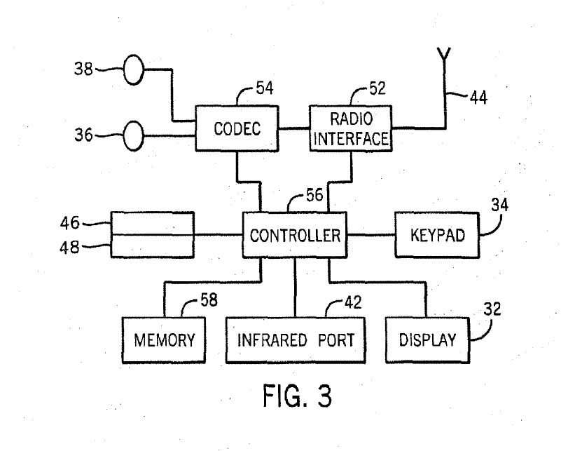

FIGS. 2 and 3 show one representative mobile telephone 12 within which the present invention may be implemented. It should be understood, however, that the present invention is not intended to be limited to one particular type of mobile telephone 12 or other electronic device. Some or all of the features depicted in FIGS. 2 and 3 could be incorporated into any or all of the devices represented in FIG. 1.

The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The implementation of the present invention according to various embodiments is based upon the SVC standard and progressive coding. However, it should be noted that the present invention is also applicable to other scalable coding methods, as well as interlace coding.

In terms of encoding, a two-pass encoding can be applied in various embodiments of the invention. In the first pass, only one slice group is used and the encoding is performed as usual, identifying which MBs are used for inter-layer prediction and which MBs are not used for inter-layer prediction and, for each of the MBs that are used for inter-layer prediction, identifying whether the residual data is used for inter-layer prediction and whether the motion data is used for inter-layer prediction. The MBs can be categorized into the following four types:

1. No data from the MB is needed for inter-layer prediction (Type A).

2. Both the residual data and the motion data are needed for inter-layer prediction (Type B).

3. The residual data is not needed while the motion data is needed for inter-layer prediction (Type C).

4. The residual data is needed while the motion data is not needed for inter-layer prediction (Type D).

It should be noted that, for a MB used for inter-layer motion prediction, the motion data of the MB may be either directly or indirectly used for inter-layer prediction of the motion data of an enhancement layer MB. This, for example, is shown below, where the decoding order is from left to right. No data of a MB in picture 2 with dependency_id equal to 0, denoted as 2(0), is needed for decoding of picture 2(1). However, the motion data of the MB in picture 2(0) is needed for the motion derivation of a direct mode MB in picture 3(0), and the motion data of the direct mode MB in picture 3(0) is used for direct inter-layer motion prediction of a MB in picture 3(1). In this case, the motion data of the MB in picture 2(0) is indirectly used for inter-layer prediction.
dependency_id=1 . . . 1 2 3 4 5 . . .
dependency_id=0 . . . 1 2 3 4 5 . . .

In the second pass, depending upon the results of the number of MBs of each of the four types discussed above, at least two slice groups, in addition to possibly data partitioning, are used for the encoding as explained in the following embodiments.

In addition to the above, it is also possible to apply a one-pass encoding, wherein it is estimated to which of the four types a MB belongs. The estimation can take the coding context and the video signal characteristics into consideration.

In one embodiment of the invention, all of the type A MBs are encoded in a first slice group and are coded as one or more slice NAL units, and each of the slice NAL units is identified to be unneeded for inter-layer prediction, e.g. by setting the discardable_flag to 1. At the same time, other MBs are encoded in a second slice group and coded as one or more slices NAL units, with each of the slice NAL units identified as needed for inter-layer prediction, e.g. by setting the discardable_flag to 0. No data partitioning support is needed for this embodiment.

In another embodiment of the invention, all of the type A MBs are encoded in a first slice group and are coded as one or more slice NAL units. Each of the slice NAL units is identified to be unneeded for inter-layer prediction, e.g. by setting the discardable_flag to 1. All of the type B and type D MBs are coded in a second slice group and are coded as one or slice NAL units. Each of the slice NAL units is identified as needed for inter-layer prediction, e.g. by setting the discardable_flag to 0. All of the type C MBs are coded in a third slice group and are coded as one or more slices. Each of these slices is further coded into at least two data partition NAL units, wherein the residual data and other data are coded in different data partition NAL units. A NAL unit containing the residual data is identified as unneeded for inter-layer prediction, e.g. by setting the discardable_flag to 1, while a NAL unit containing other data is identified as needed for inter-layer prediction, e.g. by setting the discardable_flag to 0. In this embodiment of the invention, the data partitioning arrangement in the AVC specification can be applied for AVC-compatible coded pictures. For pictures coded using SVC specific extensions, i.e. using NAL unit types 10 and 21, the AVC data partitioning arrangement can be extended and then used. The method to extend the AVC data partitioning arrangement is as follows. For type D MBs, even though the motion data is not needed for inter-layer prediction, it must be transmitted, because as the data partitioning scheme does not support the separation of motion data from other header data, e.g. slice header and MB mode information.

The current SVC standard does not yet support data partitioning for enhancement layer slices with a dependency_id larger than 0 or a quality_level larger than 0, for which NAL unit types 20 or 21 are used. To extend the AVC data partitioning arrangement for pictures coded using SVC extensions, two or three new NAL unit types (corresponding to two or three types of data partitions) can be used.

When two new NAL unit types are used, two types of data partitions are defined. The first type of data partition, defined as data partition A in the scalable extension and denoted as DPa, corresponds to the current data partition A. The second type of data partition corresponds to the combination of the current data partition B and C, and is defined as data partition B in the scalable extension and denoted as DPb. NAL unit types 22 and 23 are used for DPa and DPb, respectively. Therefore, the following table of NAL unit types is applicable:

| | Content of NAL unit and | |
|---|---|---|
| nal_unit_type | RBSP syntax structure | C |
| 0 | Unspecified | |
| 1 | Coded slice of a non-IDR picture | 2, 3, 4 |
| | slice_layer_without_partitioning_rbsp( ) | |
| 2 | Coded slice data partition A | 2 |
| | slice_data_partition_a_layer_rbsp( ) | |
| 3 | Coded slice data partition B | 3 |
| | slice_data_partition_b_layer_rbsp( ) | |
| 4 | Coded slice data partition C | 4 |
| | slice_data_partition_c_layer_rbsp( ) | |
| 5 | Coded slice of an IDR picture | 2, 3 |
| | slice_layer_without_partitioning_rbsp( ) | |
| 6 | Supplemental enhancement information (SEI) | 5 |
| | sei_rbsp ( ) | |
| 7 | Sequence parameter set | 0 |
| | seq_parameter_set_rbsp( ) | |
| 8 | Picture parameter set | 1 |
| | pic_parameter_set_rbsp( ) | |
| 9 | Access unit delimiter | 6 |
| | access_unit_delimiter_rbsp( ) | |
| 10 | End of sequence | 7 |
| | end_of_seq_rbsp( ) | |
| 11 | End of stream | 8 |
| | end_of_stream_rbsp( ) | |
| 12 | Filler data | 9 |
| | filler_data_rbsp( ) | |
| 13 | Sequence parameter set extension | 10 |
| | seq_parameter_set_extension_rbsp( ) | |
| 14...18 | Reserved | |
| 19 | Coded slice of an auxiliary coded picture | 2, 3, 4 |
| | without partitioning | |
| | slice_layer_without_partitioning_rbsp( ) | |
| 20 | Coded slice of a non-IDR picture in scalable | 2, 3, 4 |
| | extension | |
| | slice_layer_in_scalable_extension_rbsp( ) | |
| 21 | Coded slice of an IDR picture in scalable | 2, 3 |
| | extension | |
| | slice_layer_in_scalable_extension_rbsp( ) | |
| 22 | Coded slice data partition A in scalable | 2 |
| | extension | |
| | slice_data_partition_a_scalable_rbsp( ) | |
| 23 | Coded slice data partition B in scalable | 3, 4 |
| | extension | |
| | slice_data_partition_b_scalable_rbsp( ) | |
| 24...31 | Unspecified | |

The syntax of DPa is as follows:

| | | |
|---|---|---|
| slice_data_partition_a_scalable_rbsp( ) { | C | Descriptor |
| slice_header_in_scalable_extension( ) | 2 | |
| slice_id | All | ue(v) |
| slice_data_in_scalable_extension( ) /* | 2 | |
| only category 2 parts of the syntax */ | | |
| rbsp_slice_trailing_bits( ) | 2 | |
| } | | |

The syntax of DPb is as follows:

| | | |
|---|---|---|
| slice_data_partition_b_scalable_rbsp( ) { | C | Descriptor |
| slice_id | All | ue(v) |
| if( redundant_pic_cnt_present_flag ) | | |
| redundant_pic_cnt | All | ue(v) |
| slice_data_in_scalable_extension( ) /* | 3 \| 4 | |
| only categories 3 and 4 parts of the syntax */ | | |
| rbsp_slice_trailing_bits( ) | 3 \| 4 | |
| } | | |

When three new NAL unit types are used, three types of data partitions are specified, i.e. data partition A in scalable extension (denoted as DPa), data partition B in scalable extension (denoted as DPb) and data partition C in scalable extension (denoted as DPc), corresponding to the AVC data partition A, data partition B and data partition C, respectively. However, there are only two NAL units types (22 and 23) left that could be used for this purpose. The reserved NAL unit types 14 to 18 must precede the first VCL NAL unit of an access unit as constrained by AVC. To solve this issue, the NAL unit type value space can be extended. The extended NAL unit types can also be used with the case using two new NAL unit types. To extend NAL unit types, either NAL unit type 22 or 23 for extension are used. Assuming that NAL unit type 23 is used for this purpose, then the NAL unit syntax becomes as follows.

| | | |
|---|---|---|
| nal_unit( NumBytesInNALunit) { | C | Descriptor |
| forbidden_zero_bit | All | f(1) |
| nal_ref_idc | All | u(2) |
| nal_unit_type | All | u(5) |
| if( nal_unit_type = = 23) { | | |
| nal_unit_type_extension | All | u(8) |
| NalUnitType = | | |
| nal_unit_type_extension + 32 | | |
| }else | | |
| NalUnitType = nal_unit_type | | |
| nalUnitHeaderBytes = 1 | | |
| if( nal_unit_type = = 20 ∥ | | |
| nal_unit_type = = 21) { | | |
| nal_unit_header_svc_extension( ) | | |
| /* specified in Annex F */ | | |
| } | | |
| NumBytesInRBSP = 0 | | |
| for( i = nalUnitHeaderBytes; i < | | |
| NumBytesInNALunit; i++ ) { | | |
| if( i + 2 < NumBytesInNALunit && | | |
| next_bits( 24 ) = = 0×000003 ) { | | |
| rbsp_byte[ NumBytesInRBSP++ ] | All | b(8) |
| rbsp_byte[ NumBytesInRBSP++ ] | All | b(8) |
| i += 2 | | |
| emulation_prevention_three_byte /* | All | f(8) |
| equal to 0×03 */ | | |
| } else | | |
| rbsp_byte[ NumBytesInRBSP++ ] | All | b(8) |
| } | | |
| } | | |

The nal_unit _type_extension, together with nal_unit_type, specifies the NAL unit type NalUnitType. If nal_unit_type is equal to 23, then NalUnitType is equal to nal_unit type_extension plus 32. Otherwise, NalUnitType is equal to nal_unit_type. For DPa, DPb and DPc, the NAL unit types 32, 33, and 34 can be used. In this situation, the Table of NAL unit types is as follows:

| | Content of NAL unit and | |
|---|---|---|
| NalUnitType | RBSP syntax structure | C |
| 0 | Unspecified | |
| 1 | Coded slice of a non-IDR picture | 2, 3, 4 |
| | slice_layer_without_partitioning_rbsp( ) | |
| 2 | Coded slice data partition A | 2 |
| | slice_data_partition_a_layer_rbsp( ) | |
| 3 | Coded slice data partition B | 3 |
| | slice_data_partition_b_layer_rbsp( ) | |
| 4 | Coded slice data partition C | 4 |
| | slice_data_partition_c_layer_rbsp( ) | |
| 5 | Coded slice of an IDR picture | 2, 3 |
| | slice_layer_without_partitioning_rbsp( ) | |
| 6 | Supplemental enhancement information (SEI) | 5 |
| | sei_rbsp( ) | |
| 7 | Sequence parameter set | 0 |
| | seq_parameter_set_rbsp( ) | |
| 8 | Picture parameter set | 1 |
| | pic_parameter_set_rbsp( ) | |
| 9 | Access unit delimiter | 6 |
| | access_unit_delimiter_rbsp( ) | |
| 10 | End of sequence | 7 |
| | end_of_seq_rbsp( ) | |
| 11 | End of stream | 8 |
| | end_of_stream_rbsp( ) | |
| 12 | Filler data | 9 |
| | filler_data_rbsp( ) | |
| 13 | Sequence parameter set extension | 10 |
| | seq_parameter_set_extension_rbsp( ) | |
| 14...18 | Reserved | |
| 19 | Coded slice of an auxiliary coded picture | 2, 3, 4 |
| | without partitioning | |
| | slice_layer_without_partitioning_rbsp( ) | |
| 20 | Coded slice of a non-IDR picture in scalable | 2, 3, 4 |
| | extension | |
| | slice_layer_in_scalable_extension_rbsp( ) | |
| 21 | Coded slice of an IDR picture in scalable | 2, 3 |
| | extension | |
| | slice_layer_in_scalable_extension_rbsp( ) | |
| 22. | Reserved | |
| 23 | Indicating an extended NAL unit type | |
| 24...31 | Unspecified | |
| 32 | Coded slice data partition A in scalable | 2 |
| | extension | |
| | slice_data_partition_a_scalable_rbsp( ) | |
| 33 | Coded slice data partition B in scalable | 3 |
| | extension | |
| | slice_data_partition_b_scalable_rbsp( ) | |
| 34 | Coded slice data partition C in scalable | 4 |
| | extension | |
| | slice_data_partition_c_scalable_rbsp( ) | |
| 35...287 | Reserved | |

In this situation, DPa has the same syntax as in the above DPa syntax for the two data partition types. The syntaxes for DPb and DPc in this situation are in the following two tables:

| | | |
|---|---|---|
| slice_data_partition_b_scalable_rbsp( ) { | C | Descriptor |
| slice_id | All | ue(v) |
| if( redundant_pic_cnt_present_flag ) | | |
| redundant_pic_cnt | All | ue(v) |
| slice_data_in_scalable_extension( ) /* | 3 | |
| only category 3 parts of the syntax */ | | |
| rbsp_slice_trailing_bits( ) | 3 | |
| } | | |
| slice_data_partition_c_scalable_rbsp( ) { | C | Descriptor |
| slice_id | All | ue(v) |
| if( redundant_pic_cnt_present_flag ) | | |
| redundant_pic_cnt | All | ue(v) |
| slice_data_in_scalable_extension( ) /* | 4 | |
| only category 4 parts of the syntax */ | | |
| rbsp_slice_trailing_bits( ) | 4 | |
| } | | |

In another embodiment of the invention, all of the type A MBs are encoded in a first slice group and are coded as one or more slice NAL units. Each of the slice NAL units is identified to be unneeded for inter-layer prediction, e.g. by setting the discardable_flag to 1. All of the type B MBs are coded in a second slice group and are coded as one or slice NAL units. Each of the slice NAL units is identified as needed for inter-layer prediction, e.g. by setting the discardable_flag to 0. All of the type C MBs are coded in a third slice group and are coded as one or more slices. Each of these slices is further coded into at least two data partition NAL units, wherein the residual data and other data are coded in different data partition NAL units. A NAL unit containing the residual data is identified as unneeded for inter-layer prediction, e.g. by setting the discardable_flag to 1, while a NAL unit containing other data is identified as needed for inter-layer prediction, e.g. by setting the discardable_flag to 0. All of the type D MBs are coded in a fourth slice group and are coded as one or more slices. Each of these slices is further coded into at least two data partition NAL units, wherein the motion data and other data are coded in different data partition NAL units. A NAL unit containing the motion data is identified as unneeded for inter-layer prediction, e.g. by setting the discardable_flag to 1, while a NAL unit containing other data is identified as needed for inter-layer prediction, e.g. by setting the discardable_flag to 0. In this embodiment, data partitioning arrangement that enables the separation of motion data from other header data, e.g. slice header and MB mode information, is needed. Such a data partitioning scheme is described in the following.

For this data partitioning arrangement, the same NAL unit type extension as described above is used. The data partition types, DP1, DP2 and DP3, are specified and use NAL unit types 32, 33 and 34, respectively. The syntax of DP1, DP2 and DP3 are shown in the following three tables.

| | | |
|---|---|---|
| slice_data_partition_1_scalable_rbsp( ) { | C | Descriptor |
| slice_header_in_scalable_extension( ) | 11 | |
| slice_id | All | ue(v) |
| slice_data_in_scalable_extension( ) /* | 11 | |
| only category 11 parts of the syntax */ | | |
| rbsp_slice_trailing_bits( ) | 11 | |
| } | | |
| slice_data_partition_2_scalable_rbsp( ) { | C | Descriptor |
| slice_id | All | ue(v) |
| if( redundant_pic_cnt_present_flag ) | | |
| redundant_pic_cnt | All | ue(v) |
| slice_data_in_scalable_extension( ) /* | 12 | |
| only categories 12 parts of the syntax */ | | |
| rbsp_slice_trailing_bits( ) | 12 | |
| } | | |
| slice_data_partition_c_scalable_rbsp( ) { | C | Descriptor |
| slice_id | All | ue(v) |
| if( redundant_pic_cnt_present_flag ) | | |
| redundant_pic_cnt | All | ue(v) |
| slice_data_in_scalable_extension( ) /* | 13 | |
| only category 13 parts of the syntax */ | | |
| rbsp_slice_trailing_bits( ) | 13 | |
| } | | |

The syntax elements to be marked as Category 11, in addition to the current Categories (i.e. to be included in DP1), are:
All of the syntax elements in the syntax table slice_header_in_scalable_extension( ) and in the directly or indirectly embedded syntax tables
All of the syntax elements in the syntax table slice_data in_scalable_extension( )
The following syntax elements in the syntax table macroblock_layer_in_scalable_extention( )
   base_mode_flag
   base_mode_refinement flag
   mb_type
   intra_base_flag
   pcm_alignment_zero_bit
   coded_block_pattern

The syntax elements to be marked as Category 12, in addition to the current Categories (i.e. to be included in DP2) are:
The following syntax elements in the syntax table mb_pred_in_scalable_extension( )
   motion_prediction_flag_10[ ]
   motion_prediction_flag_11[ ]
   ref_idx_10[ ]
   ref_idx_11 [ ]
   mvd_10[ ][ ][ ]
   mvd_11[ ][ ][ ]
   mvd_ref_10[ ][ ][ ]
   mvd_ref_11[ ][ ][ ]
All of the syntax elements in the syntax table sub_mb_pred_in_scalable_extension( )

The syntax elements to be marked as Category 13 in addition to the current Categories (i.e. to be included in DP3) are:
The following syntax elements in the syntax table macroblock_layer_in_scalable_extention( )
   pcm_alignment_zero_bit
   pcm_sample_luma[ ]
   pcm_sample_chroma[ ]
   transform_size_{—}8×8_flag
   mb_qp_delta
The following syntax elements in the syntax table mb_pred_in_scalable_extension( )
   prev_intra4×4_pred_mode_flag[ ]
   rem_intra4×4_pred_mode[ ]
   prev_intra8×8_pred_mode_flag[ ]
   rem_intra8×8_pred_mode[ ]
   intra_chroma_pred_mode
All the syntax elements in the syntax table residual_in_scalable_extension( ) and in the directly or indirectly embedded syntax tables

It is also possible to further split a DP3 into two data partitions, where one data partition contains the residual data of intra coded blocks, and the other data partition contains the residual data of inter coded blocks.

The signaling of the slice group map (i.e., the mapping of each macroblock to one slice group) can be accomplished in different manners. In one embodiment, the slice group map is signaled in the picture parameter set, and the slice group map type 6 is used. In the event that the number of different picture parameter sets becomes more than the maximum number (256), a parameter set update is applied, and in-band picture parameter set transmission can be applied. This embodiment can also be used for a AVC-compatible base layer, provided that it can be identified whether a slice or a slice data partition is needed for inter-layer prediction, e.g. by using SEI messages, wherein a flag is signaled for each slice or slice data partition to indicate whether the data is are used for inter-layer prediction. For AVC-incompatible layers, the discardable_flag contained in the NAL unit header can be used for the indication.

In another embodiment, when there are two slice groups, the slice group map is signaled in the picture parameter set and a new slice group map type 7 is used. As in the embodiment discussed above, when the number of different picture parameter sets becomes more than the maximum number (256), a parameter set update is applied, and in-band picture parameter set transmission can be applied. This particular embodiment cannot be used for an AVC-compatible base layer. The discardable_flag contained in the NAL unit header can be used to indicate whether the contained MBs are used for inter-layer prediction.

The syntax and changed semantics of picture parameter set after inclusion of slice group type 7, in various embodiments of the present invention is as follows.

| | | |
|---|---|---|
| pic_parameter_set_rbsp( ) { | C | Descriptor |
| pic_parameter_set_id | 1 | ue(v) |
| seq_parameter_set_id | 1 | ue(v) |
| entropy_coding_mode_flag | 1 | u(1) |
| pic_order_present_flag | 1 | u(1) |
| num_slice_groups_minus 1 | 1 | ue(v) |
| if( num_slice_groups_minus 1 > 0 ) { | | |
| slice_group_map_type | 1 | ue(v) |
| if( slice_group_map_type = = 0 ) | | |
| for( iGroup = 0; iGroup <= | | |
| num_slice_groups_minus 1; iGroup++ ) | | |
| run_length_minus 1 [ iGroup ] | 1 | ue(v) |
| else if( slice_group_map_type = = 2 ) | | |
| for( iGroup = 0; iGroup < | | |
| num_slice_groups_minus 1; iGroup++ ) { | | |
| top_left[ iGroup ] | 1 | ue(v) |
| bottom_right[ iGroup ] | 1 | ue(v) |
| } | | |
| else if( slice_group_map_type = = 3 ∥ | | |
| slice_group_map_type = = 4 ∥ | | |
| slice_group_map_type = = 5 ) { | | |
| slice_group_change_direction_flag | 1 | u(1) |
| slice_group_change_rate_minus 1 | 1 | ue(v) |
| } else if( slice_group_map_type = = 6 ) { | | |
| pic_size_in_map_units_minus 1 | 1 | ue(v) |
| for( i = 0; i <= pic_size_in_{—} | | |
| map_units_minus 1; i++ ) | | |
| slice_group_id[ i ] | 1 | u(v) |
| } else if( slice_group_map_type = = 7 ) { | | |
| pic_size_in_map_units_minus 1 | 1 | ue(v) |
| mapUnitCnt = 0 | | |
| for( i=0; mapUnitCnt <= pic_size_in_{—} | | |
| map_units_minus 1; i++ ) { | | |
| zero_run_length[ i ] | 1 | ue(v) |
| mapUnitCnt += zero_run_length[ i ] + 1 | | |
| } | | |
| } | | |
| } | | |
| num_ref_idx_10_active_minus 1 | 1 | ue(v) |
| num_ref_idx_11_active_minus 1 | 1 | ue(v) |
| weighted_pred_flag | 1 | u(1) |
| weighted_bipred_idc | 1 | u(2) |
| pic_init_qp_minus26 /* relative to 26 */ | 1 | se(v) |
| pic_init_qs_minus26 /* relative to 26 */ | 1 | se(v) |
| chroma_qp_index_offset | 1 | se(v) |
| deblocking_filter_control_present_flag | 1 | u(1) |
| constrained_intra_pred_flag | 1 | u(1) |
| redundant_pic_cnt_present_flag | 1 | u(1) |
| if( more_rbsp_data( ) ) { | | |
| transform_8×8_mode_flag | 1 | u(1) |
| pic_scaling_matrix_present_flag | 1 | u(1) |
| if( pic_scaling_matrix_present_flag ) | | |
| for( i = 0; i < 6 + 2* | | |
| transform_8 ×8_mode_flag; i++ ) { | | |
| pic_scaling_list_present_flag[ i ] | 1 | u(1) |
| if( pic_scaling_list_present_flag[ i ] ) | | |
| if( i < 6 ) | | |
| scaling_list( ScalingList4×4[ i ], 16, | 1 | |
| UseDefaultScalingMatrix | | |
| 4×4Flag[ i ] ) | | |
| else | | |
| scaling_list( ScalingList8×8[ i - 6 ], 64, | 1 | |
| UseDefaultScalingMatrix | | |
| 8×8Flag[ 1 - 6 ] ) | | |
| } | | |
| second_chroma_qp_index_offset | 1 | se(v) |
| } | | |
| rbsp_trailing_bits( ) | 1 | |
| } | | |

slice_group_map_type specifies how the mapping of slice group map units to slice groups is coded. The value of slice_group_map_type is in the range of 0 to 7, inclusive. A slice_group_map_type value equal to 0 specifies interleaved slice groups. A slice_group_map_type value equal to 1 specifies a dispersed slice group mapping. A slice_group_map_type value equal to 2 specifies one or more “foreground” slice groups and a “leftover” slice group. slice_group_map_type values equal to 3, 4, and 5 specify changing slice groups. When the num_slice_groups minus 1 value is not equal to 1, the slice_group_map_type value should not be equal to 3, 4, or 5. A slice_group_map_type value equal to 6 specifies an explicit assignment of a slice group to each slice group map unit. A slice_group_map_type value equal to 7 specifies an explicit assignment of a slice group to each slice group map unit. When the num_slice_groups minus 1 value is not equal to 1, the slice_group_map_type should not be equal to 7.

Slice group map units are specified as follows. If the frame_mbs_only_flag value is equal to 0, the mb_adaptive_frame_field_flag value is equal to 1 and the coded picture is a frame, the slice group map units are macroblock pair units. Otherwise, if the frame_mbs_only_flag value is equal to 1, or if a coded picture is a field, then the slice group map units are units of macroblocks. In other cases, (i.e., the frame_mbs_only_flag value is equal to 0, the mb_adaptive_frame_field_flag value is equal to 0 and the coded picture is a frame), the slice group map units are units of two macroblocks that are vertically contiguous, as in a frame macroblock pair of an MBAFF frame (i.e., a coded frame wherein the MB Adaptive Frame/Field coding feature in the H.264/AVC standard is used).

The zero_run_length[i] field is used to derive the map unit to slice group map when the slice_group_map_type value is equal to 7. The slice group map units identified in the mapUnitToSliceGroupMap[j] field appear in counter-clockwise box-out order, as specified in subclause 8.2.2.4 of the H.264/AVC standard.

The mapUnitToSliceGroupMap[j] is derived as follows according to various embodiments:

for( j = 0, loop = 0; j <= pic_size_in_map_units_{—}
minus 1; loop++ ) {

for( k = 0; k < zero_run_length[ loop ]; k++ )

mapUnitToSliceGroupMap[ j++ ] = 0

mapUnitToSliceGroupMap[ j++ ] = 1

}

In another embodiment of the invention, the slice group map is signaled in the slice header while, at the same time, the slice group map type (slice_group_map_type) signaled in the picture parameter set is equal to 7 (with the semantics being that the slice group map is signaled in the slice header). However, in this embodiment there is no change to the picture parameter set syntax. This embodiment cannot be used for AVC-compatible base layer. As discussed previously, the discardable_flag contained in the NAL unit header can be used to indicate whether the contained MBs are used for inter-layer prediction.

In yet another embodiment of the invention, the slice group map is signaled in the “picture header,” A NAL unit containing common parameters for all of the slice or slice data partition NAL units of a coded picture. At the same time, the slice group map type (slice_group_map_type) signaled in the picture parameter set is equal to 7 (with the semantics being that the slice group map is signaled in the “picture header” NAL unit). In this embodiment, there is no change to the picture parameter set syntax. This embodiment cannot be used for AVC-compatible base layer. Once again, the discardable_flag contained in the NAL unit header can be used to indicate whether the contained MBs are used for inter-layer prediction.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for encoding a video signal to produce a scalable bitstream, comprising at least two scalable layers, comprising:
encoding blocks of data in the video signal that are required for inter-layer prediction and blocks of data in the video signal that are not required for inter-layer prediction in separate slice groups; and
signaling a block to slice group map in the bitstream.

2. The method of claim 1, wherein blocks selected from the group consisting of blocks for which no data is not used for inter-layer prediction are encoded into at least one slice group that is separate from slice groups comprising other blocks, and wherein a NAL unit containing coded data of the blocks selected from the group is identified by a signaling in the bitstream as not needed for inter-layer prediction.

3. The method of claim 2, wherein the identification is provided in a NAL unit header.

4. The method of claim 3, wherein the identification is signaled by setting a discardable_flag to 1.

5. The method of claim 1, wherein blocks selected from the group consisting of blocks used for inter-layer intra texture prediction and blocks used for both inter-layer motion prediction and inter-layer residual prediction are encoded into at least one slice group that is separate from slice groups comprising other blocks, and wherein a NAL unit containing coded data of the blocks selected from the group is identified by a signaling in the bitstream as needed for inter-layer prediction.

6. The method of claim 5, wherein the identification is provided in a NAL unit header.

7. The method of claim 5, wherein the identification is signaled by setting a discardable_flag to 0.

8. The method of claim 1, wherein a set of blocks used for inter-layer motion prediction but not used for inter-layer residual prediction are encoded into at least one inter-layer residual prediction slice group that is separate from slice groups comprising other blocks, wherein slices in the at least one inter-layer residual prediction slice group are encoded into data partitions, and wherein a data partition NAL unit not containing residual data is identified by a signaling in the bitstream as needed for inter-layer prediction.

9. The method of claim 8, wherein each data partition NAL unit containing residual data for the slices in the at least one inter-layer residual prediction slice group is identified by a signaling in the bitstream as unneeded for inter-layer prediction.

10. The method of claim 8, wherein the identification is provided in a NAL unit header.

11. The method of claim 8, wherein the identification is signaled by setting a discardable_flag to 0.

12. The method of claim 9, wherein the identification is provided in a NAL unit header.

13. The method of claim 9, wherein the identification is signaled by setting a discardable_flag to 1.

14. The method of claim 1, wherein a set of blocks used for inter-layer residual prediction but not for inter-layer motion prediction are encoded into at least one slice group that is separate from slice groups comprising other blocks, wherein slices in the at least one inter-layer motion prediction slice group are encoded into data partitions, and wherein a data partition NAL unit containing motion data for the slices in the at least one inter-layer motion prediction slice group is identified by a signaling in the bitstream as unneeded for inter-layer prediction.

15. The method of claim 14, wherein a data partition NAL unit not containing motion data for the slices in the at least one inter-layer motion prediction slice group is identified by a signaling in the bitstream as needed for inter-layer prediction.

16. The method of claim 14, wherein the identification is provided in a NAL unit header.

17. The method of claim 14, wherein the identification is signaled by setting a discardable_flag to 1.

18. The method of claim 15, wherein the identification is provided in a NAL unit header.

19. The method of claim 15, wherein the identification is signaled by setting a discardable_flag to 0.

20. The method of claim 1, wherein blocks selected from the group consisting of blocks used for inter-layer intra texture prediction and blocks used for inter-layer residual prediction are encoded into at least one slice group that is separate from slice groups comprising other blocks, and wherein a NAL unit containing coded data of the blocks from the group is identified by a signaling in the bitstream as needed for inter-layer prediction.

21. The method of claim 20, wherein the identification is provided in a NAL unit header.

22. The method of claim 20, wherein the identification is signaled by setting a discardable_flag to 0.

23. The method of claim 1, wherein a two-pass encoding process is performed comprising a first pass and a second pass, and wherein the first pass is used to identify of the data unneeded for inter-layer prediction and the data needed for inter-layer prediction.

24. The method of claim 1, wherein a one-pass encoding process is performed, and wherein it is estimated during the one-pass encoding which data is needed for inter-layer prediction and which data is not needed for inter-layer prediction.

25. The method of claim 1, wherein the block to slice group map is signaled using a slice group map type 6 in a picture parameter set according to the SVC standard.

26. The method of claim 1, wherein the block to slice group map is signaled using a run length coding.

27. The method of claim 1, wherein the block to slice group map is signaled in the slice header.

28. The method of claim 1, wherein the block to slice group map is signaled in a picture header that contains at least one parameter common for all of the coded slices or slice data partitions of a picture.

29. A computer program product for encoding a video signal to produce a bitstream, comprising:
computer code for encoding blocks of data in the video signal that are required for inter-layer prediction and blocks of data in the video signal that are not required for inter-layer prediction in separate slice groups; and
computer code for signaling a block to slice group map in the bitstream.

30. The computer program product of claim 29, wherein blocks selected from the group consisting of blocks for which no data is not used for inter-layer prediction are encoded into at least one slice group that is separate from slice groups comprising other blocks, and wherein a NAL unit containing coded data of the blocks selected from the group is identified by a signaling in the bitstream as not needed for inter-layer prediction.

31. The computer program product of claim 30, wherein the identification is provided in a NAL unit header.

32. The computer program product of claim 31, wherein the identification is signaled by setting a discardable_flag to 1.

33. The computer program product of claim 29, wherein blocks selected from the group consisting of blocks used for inter-layer intra texture prediction and blocks used for both inter-layer motion prediction and inter-layer residual prediction are encoded into at least one slice group that is separate from slice groups comprising other blocks, and wherein a NAL unit containing coded data of the blocks selected from the group is identified by a signaling in the bitstream as needed for inter-layer prediction.

34. The computer program product of claim 33, wherein the identification is provided in a NAL unit header.

35. The computer program product of claim 29, wherein a two-pass encoding process is performed comprising a first pass and a second pass, and wherein the first pass is used to determine of data unneeded for inter-layer prediction and data needed for inter-layer prediction.

36. The computer program product of claim 29, wherein a one-pass encoding process is performed, and wherein it is estimated during the one-pass encoding which data is needed for inter-layer prediction and which data is not needed for inter-layer prediction.

37. The computer program product of claim 29, wherein the block to slice group map is signaled using a run length coding.

38. The computer program product of claim 29, wherein the block to slice group map is signaled in the slice header.

39. The computer program product of claim 29, wherein the block to slice group map is signaled in a picture header that contains at least one parameter common for all of the coded slices or slice data partitions of a picture.

40. An encoding device, comprising:
a processor; and
a memory unit operatively connected to the processor and including:
computer code for encoding blocks of data in the video signal that are required for inter-layer prediction and blocks of data in the video signal that are not required for inter-layer prediction in separate slice groups; and
computer code for signaling a block to slice group map in the bitstream.

41. A method for decoding video content, comprising:
receiving a scalable bitstream comprising at least two scalable layers, the bitstream including:
a plurality of slices, wherein slices containing blocks of data not used for inter-layer predication are identified by an identification in the bitstream, and wherein blocks of data needed for inter-layer prediction are coded in separate slice groups from blocks of data not needed for inter-layer prediction, and
a block to slice group map; and
selectively decoding the plurality of slices, wherein slices that are not in a desired layer, as indicated by the identification, are not decoded.

42. The method of claim 41, wherein the identification is provided in a NAL unit header.

43. The method of claim 42, wherein the identification is indicated by having a discardable_flag set to 1.

44. The method of claim 41, wherein blocks selected from the group consisting of blocks used for inter-layer intra texture prediction and blocks used for both inter-layer motion prediction and inter-layer residual prediction are encoded into at least one slice group that is separate from slice groups comprising other blocks, and wherein a NAL unit containing coded data of the blocks selected from the group is identified by a signaling in the bitstream as needed for inter-layer prediction.

45. The method of claim 44, wherein the identification is provided in a NAL unit header.

46. The method of claim 41, wherein a set of blocks used for inter-layer motion prediction but not used for inter-layer residual prediction are received as encoded into at least one inter-layer residual prediction slice group that is separate from slice groups comprising other blocks, wherein slices in the at least one inter-layer residual prediction slice group are encoded into data partitions, and wherein a data partition NAL unit not containing residual data is identified by a signaling in the bitstream as needed for inter-layer prediction.

47. The method of claim 46, wherein each data partition NAL unit containing residual data for the slices in the at least one inter-layer residual prediction slice group is identified by a signaling in the bitstream as unneeded for inter-layer prediction.

48. The method of claim 46, wherein the identification is provided in a NAL unit header.

49. The method of claim 46, wherein the identification is signaled by setting a discardable_flag to 0.

50. The method of claim 47, wherein the identification is provided in a NAL unit header.

51. The method of claim 47, wherein the identification is signaled by setting a discardable_flag to 1.

52. The method of claim 41, wherein a set of blocks used for inter-layer residual prediction but not for inter-layer motion prediction are encoded into at least one slice group that is separate from slice groups comprising other blocks, wherein slices in the at least one inter-layer motion prediction slice group are received as encoded into data, and wherein a data partition NAL unit containing motion data for the slices in the at least one inter-layer motion prediction slice group is identified by a signaling in the bitstream as unneeded for inter-layer prediction.

53. The method of claim 52, wherein a data partition NAL unit not containing motion data for the slices in the at least one inter-layer motion prediction slice group is identified by a signaling in the bitstream as unneeded for inter-layer prediction.

54. The method of claim 41, wherein the block to slice group map is signaled using a slice group map type 6 in a picture parameter set according to the SVC standard.

55. The method of claim 41, wherein the block to slice group map is signaled using a run length coding.

56. The method of claim 55, wherein the block to slice group map is signaled in a slice header.

57. The method of claim 55, wherein the block to slice group map is signaled in a picture header that contains at least one parameter common for each coded slice or slice data partition of a picture.

58. The method of claim 41, wherein blocks selected from the group consisting of blocks used for inter-layer intra texture prediction and blocks used for inter-layer residual prediction are encoded into at least one slice group that is separate from slice groups comprising other blocks, and wherein a NAL unit containing coded data of the blocks from the group is identified by a signaling in the bitstream as needed for inter-layer prediction.

59. The method of claim 58, wherein the identification is provided in a NAL unit header.

60. The method of claim 58, wherein the identification is signaled by setting a discardable_flag to 0.

61. A computer program product for decoding video content, comprising:
computer code for receiving a scalable bitstream comprising at least two scalable layers, the bitstream including:
a plurality of slices, wherein slices containing blocks of data not used for inter-layer predication are identified by an identification in the bitstream, and wherein blocks of data needed for inter-layer prediction are coded in separate slice groups from blocks of data not needed for inter-layer prediction, and
a block to slice group map; and
computer code for selectively decoding the plurality of slices, wherein slices that are not in a desired layer, as indicated by the identification, are not decoded.

62. A decoding device, comprising:
a processor; and
a memory unit communicatively connected to the processor and including:
computer code for receiving a scalable bitstream comprising at least two scalable layers, the bitstream including:
a plurality of slices, wherein slices containing blocks of data not used for inter-layer predication are identified by an identification in the bitstream, and wherein blocks of data needed for inter-layer prediction are coded in separate slice groups from blocks of data not needed for inter-layer prediction, and
a block to slice group map; and
computer code for selectively decoding the plurality of slices, wherein slices that are not in a desired layer, as indicated by the identification, are not decoded.
